(19) United States
(12) Patent Application Publication
(10) Pub. No.: US 2019/0084132 A1
(43) Pub. Date: Mar. 21, 2019

(54) ADJUSTABLE-SIZE WRENCH AND MULTI_TOOL

(71) Applicant: Eagle Holdings LLC, Portland, OR (US)

(72) Inventor: VAHAN M. DINIHANIAN, JR., Portland, OR (US)

(73) Assignee: Eagle Holdings LLC, Portland, OR (US)

(21) Appl. No.: 15/706,699

(22) Filed: Sep. 16, 2017

(51) Int. Cl. B25B 13/52

(52) U.S. Cl. CPC B25B 13/52; B25F 1/04

(57) ABSTRACT

Adjustable-size wrench having an elongated case defining a chain-storing elongated channel, and with an anvil fixed at one end of the case, the wrench comprising a linked driver chain adjustable around the anvil and a tooth on the anvil so as to be adapted for driving any of a number of different drivable item, e.g., nut, sizes on the anvil, the linked driver chain being adapted for being stored with a portion thereof releasably retained within the elongated case by a plurality of nubs on pedestals at least partially housed within the case. A multitool portion may further comprise a plurality of tools of at least one of a flat-head screw driver, a phillips-head screw driver, and a knife blade, each of the plurality of tools pivotably housed at least partially within a partially-enclosed elongated channel opposing and divided from the chain storing channel by a central base member.

### FIELD OF THE INVENTION

This invention relates generally to adjustable wrenches, and more particularly to a an adjustable-size wrench, either alone or adapted as part of a multi-tool, incorporating an elongated gripping member flexible in one plane but substantially not elastic so as to be not able to be stretched along its longitudinal length, for wrapping around a nut, a bolt head, a drivable item, or other object such as a pipe, for driving or loosening the same.

### BACKGROUND OF INVENTION

Prior art adjustable wrenches, also known as adjustable spanners, or popularly known in the US as a Crescent® wrench (because of the well-known Crescent® brand wrench currently from Apex Tool Group), typically have comprised a handle, a fixed jaw, and an adjustable jaw operable via a (worm screw) knurl on a pin for allowing adjustment of the adjustable jaw to accommodate any of a number of differently-sized nuts, bolt heads, or other drivable items such as a pipe.

One limitation of such adjustable spanners has been that a given-size adjustable spanner, having a certain fixed-size handle, has been somewhat limited in the number of different sizes of nuts, bolt heads, pipes, or other drivable items, etc., that have been able to be driven with such a single adjustable-size wrench. Thus if you have had an adjustable wrench that has been easily able to fit within your pants pocket, it has been relatively, and unduly, limited in the numbers of different sizes of nuts, bolt heads, pipes, or other drivable items, etc., able to be effectively driven.

Thus, there have been developed in the prior art hand tools known as chain wrenches and strap wrenches. Like the aforementioned adjustable wrench, a chain wrench typically comprises a handle, a fixed member, or anvil, (similar to the fixed jaw of the Crescent® wrench but often having teeth or knurling formed in the surface thereof), and an adjustable member such as a commonly-available drive-type, roller-type, chain comprising successive linked adjacent bushings, pins, rollers and side plates. The adjustable chain member of this prior art chain has been more permanently attached with a pin at the end of the handle at the base of the fixed member, and it has been adapted for being wrapped around a nut, bolt head, pipe, or other drivable item, etc., and releasably engaged on one or more hooks formed at an opposing portion of the fixed member. Such a chain wrench is much more highly adjustable to accommodate a greater number of sizes of nuts, bolt heads, pipes, drivable items, and the like, than one of the aforementioned adjustable wrenches.

Because the chain and teeth of such a chain wrench has done damage, for example, to a copper pipe, a PVC pipe, a painted item, or other softer-material item to be driven or held, there have been developed strap wrenches. Similar to a chain wrench, a strap wrench has comprised a handle and a fixed member, but instead of a chain fixed at one end thereof to the handle, it has been provided with a strap fixed at one end to the handle, wherein the strap has formed, or has been able to be formed by a user, into an adjustable loop able to be clamped down onto the item to be held without damaging the surface of the item. Instead of teeth on the anvil for holding the chain, a strap wrench has a redirecting member that the other end of the strap is fed through in order to hold the strap tightly around the item to be driven. Like the chain wrenches described above, such strap wrenches in the prior art have been capable of being held tightly around a larger number of sizes of items, such as pipes, or other drivable items, than an adjustable crescent wrench as described above.

A few limitations of these latter type of chain wrenches and strap wrenches, however, has been that the end of the chain, or strap, not more permanently fixed to the handle of the wrench (i.e., the loose end of the chain or strap), has simply been left to dangle, or has only been held against the handle by a user's hand during use. But more importantly, the chain or strap, of these prior art wrenches have not been provided with a means to releasably fix the chain or strap to, or within, the handle, so as to have kept it from more neatly fitting into a tool box or a user's pocket. Thus, there have not been known to the Applicant, pocket-sized chain, or strap, wrenches, and there are likewise not known to the Applicant any size of chain or strap wrench where the loose end of the chain or strap has been adapted for being releasably held by the wrench itself on the handle of the wrench. This fact has also led to the fact that there have not been made available to users such an adjustable chain wrench as part of any multi-tool.

### SUMMARY OF THE INVENTION

In accordance with a first aspect of the invention, there is provided an adjustable-size wrench adapted for tightening and loosening any of a number of differently-sized nuts, bolts, pipes, or other drivable items, comprising: an elongated case having first and second ends and upper and lower portions; an anvil comprising a base portion and an extended portion, the base portion of the anvil being attached to the first end of the case. The adjustable-size wrench of this aspect of the invention further comprises means for releasably securing fixed on the upper portion of the case. Further, the adjustable-size wrench of this aspect of the invention comprises an elongated non-elastic gripping member flexible in one plane so as to be able to be wrapped around a drivable member, but not elastic along its length so as to not be able to be stretched longitudinally, such as a nut-gripping member, a bolt-gripping member, or other drivable-item gripping member, having first and second ends and an intermediate portion, the first and second ends and intermediate portion of the elongated gripping member together comprising a longitudinal length sufficient and adapted for wrapping in one plane around and engaging any corners of a portion of the drivable item (such as a nut, a bolt head, a pipe, a shock absorber, a canister, an oil filter, etc.) while the drivable item is lodged against the extended portion of the anvil and adapted for turning the drivable item for loosening and tightening of the drivable item, with a spare portion of the intermediate portion of the elongated gripping member that is closer to, and together with, the second end of the elongated gripping member being adapted for being releasably but securely fixed on the means for releasably securing fixed on the upper portion of the case. When used in this specification, the term driven item, or drivable item, is intended to refer to both loosening and tightening turning movements of an item such as a nut, a bolt, or even a smooth pipe or tube a portion of which is threaded and can therefore be loosened or tightened with turning.

Preferably, the elongated gripping member is attached, such as pivotably attached by a pin, at the first end of the elongated gripping member to the lower portion of the case, and adjacent the base portion of the anvil. The elongated gripping member is further adapted for release from the means for releasably securing, and is further adapted for unwrapping in the plane for disengaging the drivable item.

Thus, in accordance with another embodiment and aspect of the invention, there is provided an adjustable-size wrench, wherein the elongated gripping member comprises a drive-type, roller-type, chain that is non-elastic along the longitudinal length thereof, the chain further comprising successive linked adjacent bushings, pins, rollers and side plates, and wherein the anvil further comprises at least one tooth member preferably on an upper surface of the anvil, the tooth member, or members, adapted for hooking between adjacent rollers of the chain for enabling torqueing of the drivable item.

In accordance with an alternative embodiment of these first two aspects of the invention, there is further provided an adjustable-size wrench, wherein the means for releasably securing comprises a magnetized member for releasably securing the elongated gripping member, or chain.

In accordance with another aspect and embodiment of the invention, there is provided an adjustable-size wrench, wherein the means for releasably securing comprises a plurality of nubbed pedestals adapted for press fitting in-between adjacent rollers on the drive-type, roller-type chain described above in accordance with a previous aspect of the invention. These nubbed pedestals are preferably carried on the case, or handle, of the invention, and may either be on an upper surface of the case, or recessed in a channel portion formed in the case, or handle.

Thus, in accordance with the foregoing aspects and embodiments of the invention, there is provided an adjustable-size wrench, wherein the case, or handle, further defines an opening along the upper portion of the case, so as to allow the means for releasably securing, or retaining, such as a plurality of nubbed pedestals comprised of plastic, or alternatively comprised of metal, a magnetic strip, or still further alternatively press-fit sidewalls along the upper portion of the case, to be retained within the case, or handle.

Thus, in accordance with another aspect of the invention, the means for releasably securing the loose end of the elongated drivable-item gripping member, such as the plurality of nubbed pedestals, may be at least partially housed within the channel—that is with upper portions of the nubbed pedestals sticking partially above a plane of an upper surface of the case, or handle, and with at least lower portions of the nubbed pedestals—or alternatively all of the nubbed pedestals being housed within the case, or handle—that is with the upper portions of the nubbed pedestals residing below the plane of an upper surface of the case, or handle.

In accordance with another embodiment and aspect of the invention, there is provided an adjustable-size wrench, wherein the lower portion of the elongated case for the adjustable-size wrench further defines an at least partially-enclosed channel in the lower portion of the case, and further comprising a plurality of tools of at least one of a flat-head screw driver, a phillips-head screw driver, and a knife blade, each of the plurality of tools pivotably housed at least partially within the channel defined in the lower portion of the case and adapted for pivoting outside the channel for use by a user.

Thus, in accordance with the foregoing embodiments and aspects of the invention, there is provided an adjustable-size wrench, further comprising a base member forming a longitudinally extending dividing floor centrally within the channel for separating the upper and lower portions of the channel, wherein each of the plurality of nubbed pedestals in one foregoing embodiment each comprises a pedestal extending from the base member and further comprises an enlarged at least partially-rounded top on each pedestal, and wherein the maximum diameter at the enlarged at least partially-rounded top of each nubbed pedestal is adapted to be positioned above a diametric centerline of horizontally-positioned adjacent rollers of the chain when linked side plates of the chain rest on the floor of the base member with the rollers of the chain press-fitted over the at least partially-rounded tops on the pedestals.

In accordance with an embodiment and foregoing aspect of the invention, there is provided an upper portion of the elongated case further defining at least a partially-enclosed channel in the upper portion of the case such that an opening in an upper portion of the case is an elongated opening to the channel, wherein the plurality of nubbed pedestals are housed at least partially within the storage channel in the upper portion of the case, and further comprising a plurality of tools of at least one of a flat-head screw driver, a phillips-head screw driver, a hex-head driver, a star-head driver, and a knife blade, each of the plurality of tools pivotably housed at least partially within the storage channel defined in the lower portion of the case and adapted for pivoting exposure and use by a user.

In an embodiment of one of the foregoing aspects of the invention, each of the plurality of nubbed pedestals comprises a pedestal with an enlarged at least partially-rounded top thereon, and wherein the maximum diameter at the enlarged at least partially-rounded top is adapted to be positioned above a diametric centerline of horizontally-positioned adjacent rollers of the chain for securely, but releasably, holding excess chain during one of storage and use of the wrench.

Further, the previously described channel is preferably defined by the lower portion of the case further comprising a plurality of elongated sidewalls, wherein at least one of the plurality of elongated sidewalls is partially recessed at a lowermost portion thereof adapted to allow easy access to at least one of the plurality of tools by a user.

The elongated gripping member of the adjustable-size wrench of this aspect of the invention may comprise a drive-type roller-type chain further comprising successive linked adjacent roller bushings, pins and side plates.

In an alternative embodiment of the invention, the adjustable-size wrench may alternatively comprise means for releasably securing comprising a magnetized member for releasably securing the elongated gripping member on an upper portion of, or in an upper channel of, the case of the adjustable-size wrench.

In an alternative embodiment of the invention, there is provided an adjustable-size wrench, wherein the means for releasably securing the elongated gripping member comprises a press-fit channel defined in the upper portion of the case for releasably retaining a portion of the elongated gripping member adjacent the second end thereof. In such an embodiment, the channel may be lined with a plastic material that flexes somewhat to hold upon the longitudinally-extending sides of the elongated gripping member, as with slight pressure from the user pressing a left over portion, or spare portion, of the elongated gripping member, either during storage or use of the device, into the press-fit channel sides.

In accordance with one or more of the foregoing aspects of the invention, there is provided an embodiment of an adjustable-size-wrench-type multi-tool, comprising: an elongated case comprising first and second ends, and upper and lower portions, the upper and lower portions of the elongated case each defining an at least partially-enclosed channel having elongated side walls, and optionally one or more end walls, the case further comprising a central channel dividing member for dividing the upper and lower at least partially-enclosed channels such that each channel defines upper and lower elongated openings. The adjustable-size-wrench-type multi-tool of this embodiment of the invention further comprises an anvil comprising a base portion and an extended portion, the base portion of the anvil being attached to the first end of the case, and a plurality of nubbed pedestals at least partially housed within the at least partially-enclosed channel defined in the upper portion of the case, each nubbed pedestal comprising a pedestal portion and an at least partially-rounded head portion. Further, this aspect of the invention further comprises an elongated drive-chain-type gripping member comprising successive linked adjacent rollers, pins and side plates, first and second ends and an intermediate portion, the first and second ends and intermediate portion of the elongated gripping member together comprising a longitudinal length sufficient and adapted for wrapping in one plane around and engaging any corners of a drivable item lodged against the extended portion of the anvil and adapted for turning the drivable item for loosening and tightening of the drivable item. A portion of the intermediate portion of the elongated gripping member that is closer to the second end of the elongated gripping member, as well as the second end of the elongated gripping member, are adapted for being releasably but securely fixed on the plurality of nubs for releasably securing the elongated gripping member at least partially within the upper partially-enclosed channel of the case. The elongated gripping member is attached at the first end thereof to the lower portion of the case, adjacent the first end of the case, and adjacent the base portion of the anvil, and the elongated gripping member is further adapted for release from the plurality of nubbed pedestals and unwrapping in the plane for disengaging the drivable item.

Still further, this embodiment of the invention preferably comprises a plurality of tools, of at least one of a flat-head screw driver, a phillips-head screw driver, a hex-head driver, a star-head driver, and a knife blade, and each of such plurality of tools is pivotably housed at least partially within the at least partially-enclosed channel defined in the lower portion of the case, wherein each of such plurality of tools is adapted for pivoting exposure and use by a user.

Preferably, in accordance with this embodiment of an adjustable-size wrench multi-tool in accordance with one or more aspects of the invention, preferably the maximum diameter at the enlarged at least partially-rounded top of each nubbed pedestal is adapted to be positioned above a diametric centerline of horizontally-positioned adjacent rollers of the elongated drive-chain-type gripping member. In this way the elongated drive-chain-type gripping member is able to be pressed onto the nubbed heads of one or more of the plurality of nubbed pedestals in order to releasably retain the elongated drive-chain-type gripping member in position relative to, and partially housed in, the upper channel of the case.

In accordance with another alternative embodiment of any of the foregoing aspects of the invention, the means for releasably securing the loose end of the elongated drivable-item gripping member may be provided as an enclosed channel in the upper portion of the case with a spring-loaded, thumb-release-type, ratchet and pawl system at the opening to the channel. In such a system, the elongated drivable-item gripping member may be partially stored in the channel where it passes through the opening in the channel, and may comprise a plurality of pawl-type teeth adapted for engaging with the teeth on a spring-and-thumb-release-type ratchet wheel rotatably housed in the end of the case near the anvil and near the opening to the channel. The pawl-type teeth on the elongated drivable-item gripping member also help grip corners on nuts and bolts, as well as other material types for items to be driven. The ratchet wheel of the ratchet and pawl system is preferably carried via a bushing or bearings on an axle at the end of the case adjacent the base of the anvil of the adjustable-size wrench, and the ratchet wheel is able to be disengaged from the pawl via depression of a spring-loaded lever pulling the pawl away from the ratchet wheel to allow disconnecting of the ratchet wheel and pawl, thus allowing loosening of the elongated drivable-item gripping member.

The foregoing aspects and embodiments of the invention address the limited number of sized drivable items that can be driven with a single, pocket-ready, adjustable wrench. Further, the foregoing aspects and embodiments of the invention provide a handy way of releasably retaining the elongated drivable-item gripping member so that it doesn't get tangled up in a user's pocket or toolbox. And these features and benefits, in turn, make an adjustable-size wrench in accordance with the present invention particularly well-suited to be adapted as part of a multi-tool, particularly one that is small enough to fit easily in a user's pocket.

The case, or handle, the anvil, and a chain-type elongated drivable-item gripping member are all preferably comprised of steel. The tools of the multi-tool, and pivot pins, are also preferably comprised of steel.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIG. 1 is a perspective illustration of an adjustable-size wrench multi-tool in accordance with an embodiment and aspects of the invention;

FIG. 2 is a side elevation view of an alternative embodiment adjustable-size wrench multi-tool in accordance with an embodiment and aspects of the invention;

FIG. 3 is a top plan view of a central base member having a plurality of nubbed pedestals thereon for intermediate, or base, insertion into a channel of an adjustable-size wrench tool, or multi-tool;

FIG. 4 is a side elevation view of the central base member of FIG. 3 having a plurality of nubbed pedestals thereon for intermediate, or base, insertion into a channel of an adjustable-size wrench tool, or multi-tool;

FIG. 5 is a side elevation view of an embodiment of an adjustable-size wrench multi-tool having a plurality of nubbed pedestals as a releasable retaining member shown partially within an upper channel of the case and for holding a chain-type elongated gripping member;

FIG. 6 is a bottom view of an embodiment of an adjustable-size wrench multi-tool in accordance with an aspect of the invention;

FIG. 7 is a side elevation view of an alternative embodiment of an adjustable-size wrench multi-tool in accordance with an aspect of the invention;

FIG. 8 is a side elevation view of an embodiment of an adjustable-size wrench in accordance with an aspect of the invention;

FIG. 9 is a top plan view of an embodiment of an adjustable-size wrench in accordance with an aspect of the invention; and

FIG. 10 is a side view of an alternative embodiment of an adjustable-size wrench in accordance with an embodiment and aspect of the invention.

### DETAILED DESCRIPTION OF THE INVENTION

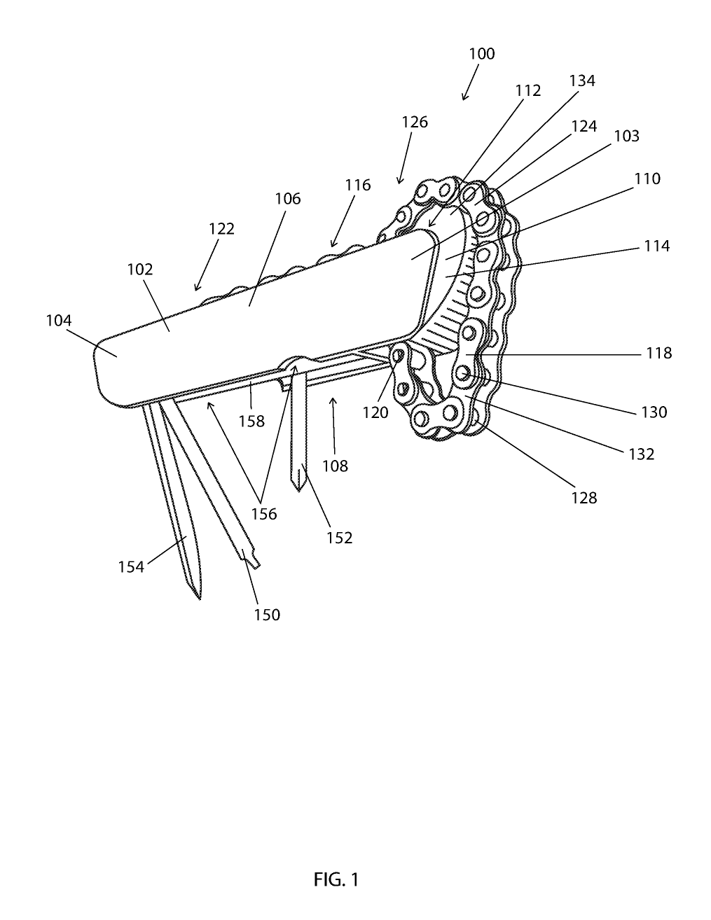

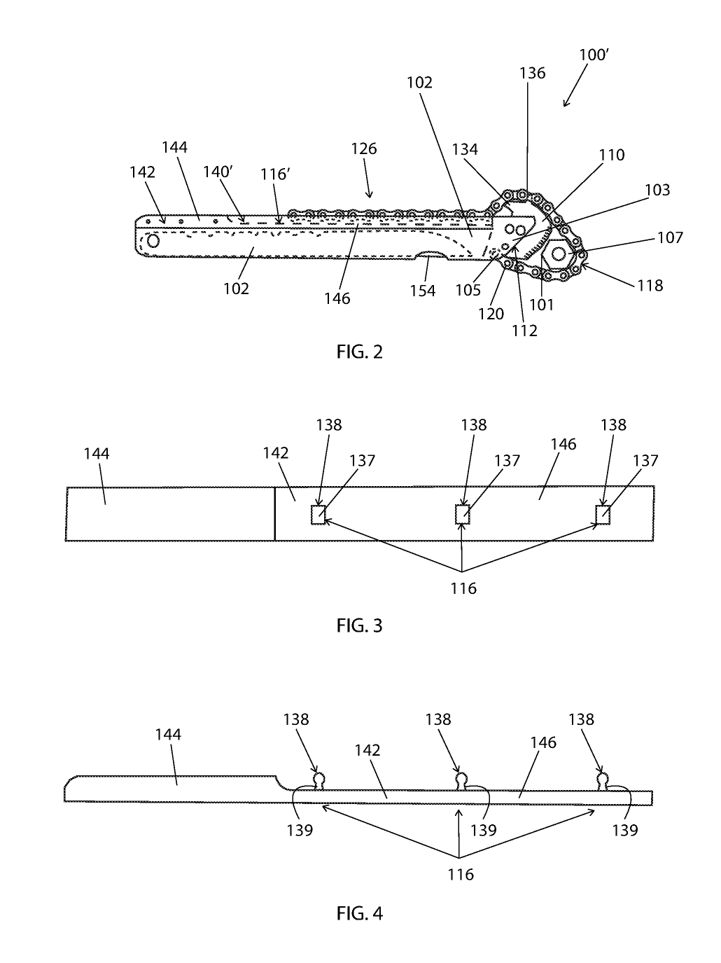

Referring specifically to FIG. 1, there is shown an embodiment of an adjustable-size wrench multi-tool 100 adapted for tightening and loosening any of a number of differently-sized nuts, bolts, pipes, or other drivable items, in accordance with an aspect of the invention. The adjustable-size wrench multi-tool 100 is comprised of an elongated case 102 having first and second ends 103, 104 and upper and lower portions 106, 108. There is further provided an anvil 110 comprising a base portion 112 and an extended portion 114, the base portion of the anvil being fixedly and rigidly attached to the first end 103 of the case 102. The adjustable-size wrench portion of the multi-tool 100 further comprises means 116 for releasably securing fixed on the upper portion 106 of the case 102. Further, the adjustable-size wrench portion of the multi-tool 100 further comprises an elongated gripping member 118, such as a nut-gripping member, a bolt-gripping member, or other drivable-item gripping member. The elongated gripping member 118 has first and second ends 120, 122 and an intermediate portion 124. The first and second ends 120, 122 and intermediate portion 124 of the elongated gripping member 118 together comprise a longitudinal length sufficient and adapted for wrapping in one plane around and engaging any corners 101 of a portion of a drivable item 107 (such as the corners 101 of a nut 107 shown in FIG. 2, or a bolt head; or in the case where there are no such corners, a pipe, a shock absorber, a canister, an oil filter, etc.). The elongated gripping member 118 is flexible in one plane so as to be able to be wrapped around the drivable item, but it is not elastic along its length, so as to be substantially unable to be stretched along its longitudinal length.

During driving, the drivable item 107 is also lodged against the extended portion 114 of the anvil 110, such that the adjustable-size wrench is adapted for turning the drivable item for loosening and tightening of the same. A spare portion 126 of the intermediate portion 124 of the elongated gripping member 118 that is adjacent to, and together with, the second end 122, of the elongated gripping member being adapted for being releasably but securely fixed on the means for releasably securing 116 fixed on the upper portion of the case 102.

When used in this specification, the term driven item, or drivable item, is intended to refer to both loosening and tightening turning movements of an item such as a nut, a bolt, or even a smooth pipe or tube a portion of which is perhaps threaded and can therefore be loosened or tightened with turning of the larger, perhaps exposed, portion of the drivable item.

Preferably, the elongated gripping member 118 is attached, such as pivotably attached by a pin 105 (shown in dotted lines in FIG. 2), at the first end 120 of the elongated gripping member to the lower portion of the first end 103 of the case 102, and adjacent the base portion 112 of the anvil 110. The elongated gripping member 118 is further adapted for release from the means for releasably securing 116, and is further adapted for unwrapping in the plane for disengaging the drivable item 107.

Preferably, in accordance with an embodiment and aspect of the invention, the elongated gripping member 118 comprises a drive-type, roller-type, chain that is flexible in one plane, but non-elastic so as to be not elongated along the longitudinal length thereof, the chain further comprising successive linked adjacent rollers 128, pins 130 and side plates 132, and wherein the anvil 110 further comprises at least one tooth member 134 preferably on an upper surface of the anvil, the tooth member, or members (see 134 and 136 in FIG. 2), adapted for hooking between adjacent rollers 128 of the chain (e.g., elongated gripping member 118) for enabling torqueing of the drivable item 107.

Preferably, and in accordance with an embodiment and aspect of the invention, the means for releasably securing 116 of the adjustable-size wrench 100 comprises a plurality of nubbed pedestals 138 adapted for press fitting in-between adjacent rollers 128 on the drive-type, roller-type chain 118 described above in accordance with a previous aspect of the invention. The nubbed pedestals 138 are preferably carried on the case 102, otherwise known as a handle portion 102, of the adjustable-size wrench 100, and may either be on an upper surface of the case, or recessed in an upper channel portion 140 formed in the case 102, or handle, for example as shown in FIG. 2.

As shown more specifically in FIGS. 3 and 4, each nubbed pedestal 138 may preferably be formed on a base 142 adapted for attachment on the upper surface of the case 102, or along the bottom of the channel portion 140 of an adjustable-size wrench as shown, for example, in FIG. 5. In an embodiment comprising a channel portion 140, the base 142 has an upper non-recessed portion 144, and a lower recessed portion 146, to help form the base of the channel portion 140 as shown with dotted lines, for example, in FIG. 5. The base 142 and the plurality of nubbed pedestals 138 are comprised of plastic, or alternatively they may be comprised of metal.

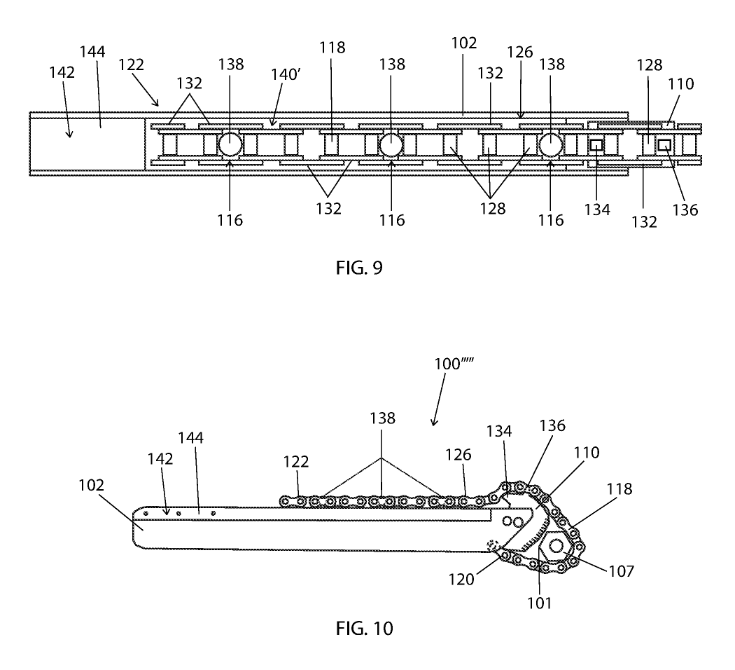

Referring specifically, to FIG. 2, in accordance with an alternative embodiment, there is provided an adjustable-size wrench 100′, there is provided an alternate means for releasably securing 116′ comprising a magnetized member 116′ for releasably securing the elongated gripping member, or chain 118. Thus, instead of a plurality of nubbed pedestals 138, as shown for example in FIGS. 5 and 9, the magnetized member 116′ shown in FIG. 2 for releasably securing the chain 118 relies primarily on magnetic attraction to keep the chain in place in a channel 140′, either during use rotating a drivable item 107, wherein only a smaller portion of the chain 118 (including the spare portion 126 (i.e., second end 122 and part of intermediate portion 124) is retained by the magnetized member 116′ in the channel 140′, or during storage, wherein a larger portion of the chain (i.e., second end 122 and a larger part of intermediate portion 124) is retained by the magnetized member in the channel 140′. In this way, the tool is able to be stored neatly in a user's pocket or tool box, without the chain getting tangled with other things.

Referring now to FIG. 8, there is provided an alternative embodiment adjustable-size wrench 100″″, wherein the means for releasably securing 116″ the elongated gripping member 118 comprises a press-fit channel 140″ defined in the upper portion of the case 102 for releasably retaining a portion of the elongated gripping member adjacent the second end 122 thereof. In such an embodiment, the channel 140″ may be lined with a plastic material that flexes somewhat to hold upon the longitudinally-extending sides of the elongated gripping member 118, as with slight pressure from the user pressing a left over portion, or spare portion 126, together with loose (second) end 122, of the elongated gripping member either during storage or use of the device.

In accordance with an aspect of the invention, the means for releasably securing 116, the loose (second) end 122 of the elongated drivable-item gripping member 118, may comprise a plurality of nubbed pedestals 138 which may be at least partially housed, that is recessed within, the channel 140, that is with upper portions (the at least partially rounded nubs) 137 of the nubbed pedestals sticking partially above a plane of an upper surface of the case 102, or handle, and with at least lower (the pedestal) portions 139 of the nubbed pedestals being housed within the case. Alternatively all of the nubbed pedestals 138 may be housed within the recessed channel 140 of the case 102, or handle—that is, with even the upper portions 137 of the nubbed pedestals 138 residing below the plane of an upper surface of the case 102, or handle.

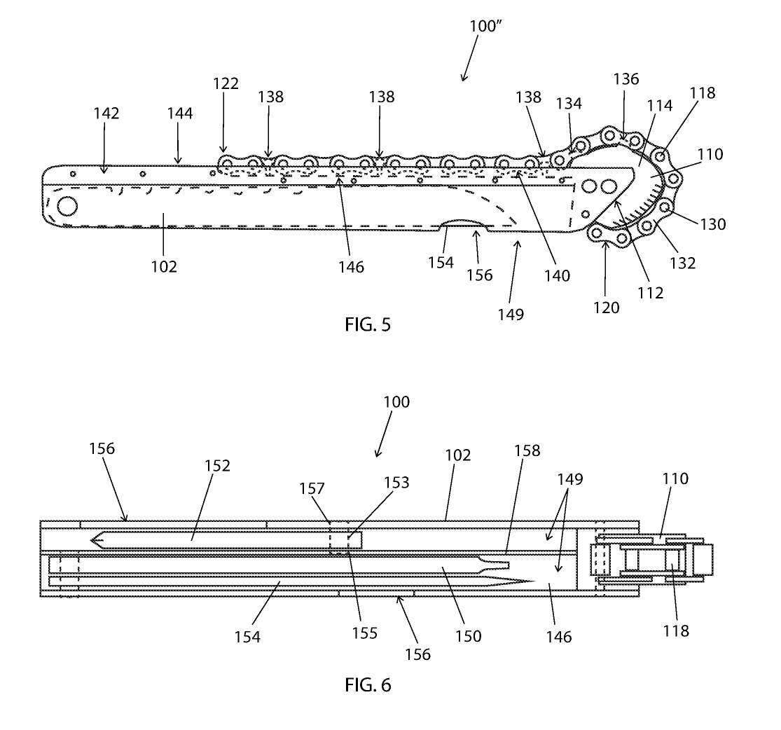

In accordance with another aspect of the invention, as shown for example in FIGS. 1 and 6, the lower portion 108 of the elongated case 102 for the adjustable-size wrench 100 further defines an at least partially-enclosed channel, or channels, 149 in the lower longitudinally extending portion of the case, and further comprises a plurality of tools of at least one of a flat-head screw driver 150, a phillips-head screw driver 152, and a knife blade 154, each of the plurality of tools pivotably housed at least partially within the channel(s) 149 defined in the lower portion of the case and adapted for pivoting outside the channel(s) for use by a user.

There is provided a divider 158 creating a plurality of channels 149 and for allowing pivoting of one or more of the plurality of tools at a midpoint of the adjustable-size wrench multi-tool 100. For example, there may be provided, as shown in FIG. 6, a phillips-head screw driver 152, or others of the tools, that is pivoted in one of the channels 149 at an approximate midpoint of the elongated case 102, as is known in the art, and to provide means to bare down on the driver (i.e., the phillips-head screw driver 152) with the palm of a user's hand on the elongated case. There is also provided an indented portion 156 of a lower wall portion of the case 102, to allow the user to more easily access tools with the user's fingers. To facilitate the midpoint pivoting of the driver 152, the divider 158 is integrated into the structure of the case 102 of the adjustable multi-tool 100 as is known in the art, to help retain an end 155 of a pivot shaft 153, whereas another end 157 of the pivot shaft is retained in an outer wall of the case 102.

Thus, as illustrated in FIGS. 1, 2, 5, 6 and 8, in accordance with the foregoing embodiments and aspects of the invention, there is provided an adjustable-size wrench 100, 100′, 100″, 100″″ further comprising a base member 142 (See also FIGS. 3 and 4) forming a dividing floor 146 centrally within the case 102 for separating (or for resting on a structural separating floor), the case into upper and lower channels 140, 149. Further, each of the plurality of nubbed pedestals 138 in one embodiment (e.g., that of FIGS. 3-5), each preferably comprises a pedestal 139 extending from the base member 142, and further comprises an enlarged, at least partially rounded, top 137 on each pedestal. A maximum horizontal diameter of the enlarged, at least partially rounded, top 137 of each nubbed pedestal 138 is adapted to be positioned above a horizontal diametric centerline of horizontally-positioned adjacent rollers 128 of the chain when linked side plates 132 of the chain rest on the floor 146 of the base member 142. Thus, in this position the rollers 128 of the chain 118 are press-fitted over the at least partially rounded tops 137 on the pedestals 139 such that the chain is releasably held in place subject to be pulled off by the user to adjust or otherwise use the adjustable-size wrench 100, 100′, 100″, 100″″.

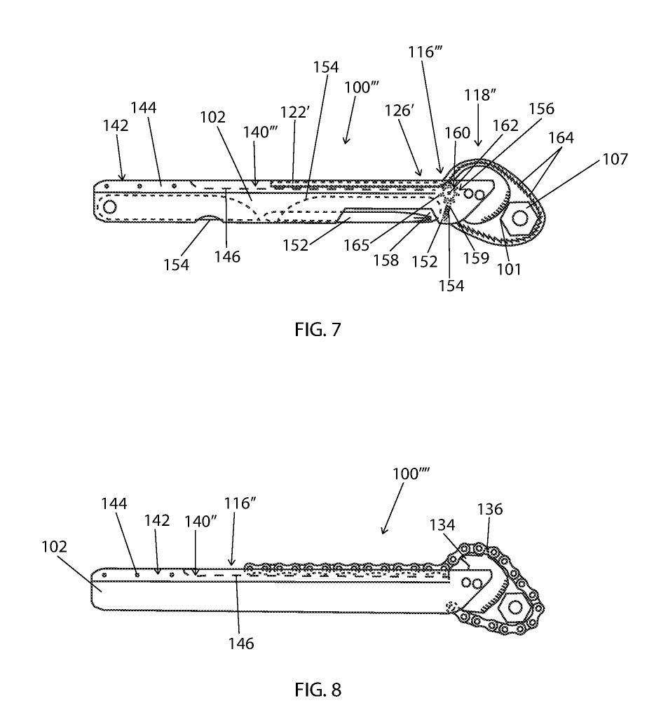

Referring now to FIG. 7, in accordance with another alternative embodiment of any of the foregoing aspects of the invention, the means for releasably securing 116′″ a loose end 122′, and a spare portion 126′ of the elongated drivable-item gripping member 118′ may be provided as an enclosed channel 140′″ in the upper portion of the case 102 with a spring-loaded 152, thumb-release-type 154, ratchet 156 and pawl 159 system located at an opening 160 to the channel 140″′. In such a system, the elongated drivable-item gripping member 118′ may be partially stored in the channel 140″′ where it passes through the opening 160 in the channel, and may comprise a plurality of pawl-type teeth 164 adapted for engaging with the teeth 165 on the spring-and-thumb-release-type ratchet wheel 156 rotatably housed in the end 103 of the case 102 near the anvil 110 and near the opening 160 to the channel 140′. The pawl-type teeth 164 on the elongated drivable-item gripping member 118′ also helps to grip corners 101 on nuts and bolts 107, as well as other material types for items 107 to be driven. The ratchet wheel 156 of the ratchet 156 and pawl 159 system is preferably carried via a bushing or bearings on an axle 162 at the end of the case 102 adjacent the base 112 of the anvil 110 of the adjustable-size wrench 100″′, and the ratchet wheel 156 is able to be disengaged from the pawl 159, otherwise locked in a pawl ratcheted forward position, via depression of a spring-loaded lever 154 pulling the pawl away from the ratchet wheel to allow disconnecting of the ratchet wheel teeth 165 from the pawl, thus allowing free-spinning of the ratchet wheel in order to allow loosening of the elongated drivable-item gripping member 118′.

The case, or handle, the anvil, and a chain-type elongated drivable-item gripping member of the various embodiments of the invention are all preferably comprised of steel. The tools of the multi-tool, and pivot pins, are also preferably comprised of steel.

Referring to FIG. 10, in accordance with an embodiment and aspect of the invention, there is provided an adjustable-size wrench 100″″′ comprising either a magnetized means 116′, or a press-fit means 116” (or a nubbed pedestal means 116—not shown), for releasably securing and all other elements of, for example adjustable-size wrench 100, except unlike adjustable-size wrench 100, adjustable-size wrench 100″″′ does not comprise a plurality of other tools in the case, or handle, 102, but rather is simply an adjustable-size wrench adapted for driving a drivable item 107.

While a preferred embodiment of the present invention has been shown and described, it will be apparent to those skilled in the art that many changes and modifications may be made without departing from the invention in its broader aspects. For example it will be appreciated that one of ordinary skill in the art, with the benefit of this disclosure, mix and match various components of the various embodiments of the invention without departing from the true spirit of the invention as claimed. Thus, by way of example, it will be appreciated that a chain-type elongated member embodiment of the invention may be combined with either a multi-tool, or also a non-multi-tool case, a nubbed pedestal retaining member, a magnetic retaining member, or a press-fit-sides retaining member, all without departing from the scope of the invention as claimed. Further, it will be appreciated that one of ordinary skill in the art may, with the benefit of this disclosure, implement a ratchet and pawl-type retaining member and elongated gripping member, together with a multi-tool lower case, a press-fit upper case retaining member, and or a plurality of nubbed pedestals for holding down a spare, or remaining, portion of the elongated gripping member during storage or use. In such a case it will be apparent that holes may need to be added to the elongated gripping member to fit over the top of one or more nubbed pedestals, all without departing from the spirit and scope of the invention as claimed. The appended claims are therefore intended to cover all such changes and modifications as fall within the true spirit and scope of the invention.

I claim:

1. An adjustable-size wrench adapted for tightening and loosening any of a number of differently-sized nuts, bolts, pipes, or other drivable item, comprising:
an elongated case having first and second ends and upper and lower portions;
an anvil comprising a base portion and an extended portion, the base portion of said anvil being attached to the first end of said case;
means for releasably securing fixed on the upper portion of said case;
an elongated gripping member having first and second ends and an intermediate portion, the first and second ends and intermediate portion of the elongated gripping member together comprising a longitudinal length sufficient and adapted for wrapping in one plane around and engaging corners of a portion of a drivable item while the drivable item is lodged against the extended portion of said anvil and adapted for turning the drivable item for loosening and tightening of the drivable item, with a spare portion of the intermediate portion of said elongated gripping member that is closer to, and together with, the second end of said elongated gripping member being adapted for being releasably but securely fixed on said means for releasably securing fixed on the upper portion of said case, said elongated gripping member being attached at the first end thereof to the lower portion of said case and adjacent the base portion of said anvil, said elongated gripping member further adapted for release from said means for releasably securing and unwrapping in the plane for disengaging the drivable item.

2. The adjustable-size wrench of claim 1, wherein said elongated gripping member comprises a drive-type, roller-type, chain that is non-elastic along the longitudinal length thereof, said chain further comprising successive linked adjacent bushings, pins, rollers and side plates, said anvil further comprising at least one tooth member thereon adapted for hooking between adjacent rollers for enabling torqueing of the drivable item.

3. The adjustable-size wrench of claim 2, wherein said means for releasably securing comprises a magnetized member for releasably securing said elongated gripping member.

4. The adjustable-size wrench of claim 2, wherein said means for releasably securing comprises a plurality of nubbed pedestals adapted for press fitting in between adjacent rollers on the chain.

5. The adjustable-size wrench of claim 4, wherein said case further defines an opening along the upper portion of said case.

6. The adjustable-size wrench of claim 5, wherein the plurality of nubbed pedestals are comprised of plastic.

7. The adjustable-size wrench of claim 5, wherein the plurality of nubbed pedestals are comprised of metal.

8. The adjustable-size wrench of claim 6, wherein the upper portion of said elongated case further defines an at least partially-enclosed channel in the upper portion of said case such that the opening in said case is an elongated opening to the channel, and wherein the plurality of nubbed pedestals are at least partially housed within the channel.

9. The adjustable-size wrench of claim 1, wherein the lower portion of said elongated case further defines an at least partially-enclosed channel in the lower portion of said case, and further comprising a plurality of tools of at least one of a flat-head screw driver, a phillips-head screw driver, and a knife blade, each of the plurality of tools pivotably housed at least partially within the channel defined in the lower portion of said case and adapted for pivoting outside the channel for use by a user.

10. The adjustable-size wrench of claim 8, further comprising a base member forming a floor within the channel, wherein each of the plurality of nubbed pedestals comprises a pedestal extending from the base member and further comprises an enlarged at least partially rounded top on each pedestal, and wherein the maximum diameter at the enlarged at least partially rounded top is adapted to be positioned above a diametric centerline of horizontally-positioned adjacent rollers of the chain when linked side plates of said chain rest on the floor of said base member with the rollers of the chain press-fitted over the at least partially rounded tops on the pedestals.

11. The adjustable-size wrench of claim 6, wherein the upper portion of said elongated case further defines at least a partially-enclosed channel in the upper portion of said case such that the opening in said case is an elongated opening to the channel, wherein the plurality of nubbed pedestals are housed at least partially within the storage channel in the upper portion of said case, and further comprising a plurality of tools of at least one of a flat-head screw driver, a phillips-head screw driver, a hex-head driver, a star-head driver, and a knife blade, each of the plurality of tools pivotably housed at least partially within the storage channel defined in the lower portion of said case and adapted for pivoting exposure and use by a user.

12. The adjustable-size wrench of claim 11, wherein each of the plurality of nubbed pedestals comprises a pedestal with an enlarged at least partially rounded top thereon, and wherein the maximum diameter at the enlarged at least partially rounded top is adapted to be positioned above a diametric centerline of horizontally-positioned adjacent rollers of the chain for securely, but releasably, holding excess chain during one of storage and use of the wrench.

13. The adjustable size wrench of claim 9, wherein the channel defined by the lower portion of said case further comprises a plurality of elongated sidewalls, wherein at least one of said plurality of elongated sidewalls is partially recessed at a lowermost portion thereof adapted to allow easy access to at least one of the plurality of tools by a user.

14. The adjustable-size wrench of claim 13, wherein said elongated gripping member comprises a drive-type roller-type chain further comprising successive linked adjacent bushings, pins, rollers and side plates.

15. The adjustable-size wrench of claim 14, wherein said means for releasably securing comprises a magnetized member for releasably securing said elongated gripping member.

16. The adjustable-size wrench of claim 14, wherein said means for releasably securing comprises a plurality of nubbed pedestals adapted for press fitting in between adjacent rollers on the chain.

17. The adjustable-size wrench of claim 16, wherein said case further defines an opening along the upper portion of said case.

18. The adjustable-size wrench of claim 1, wherein the means for releasably securing the elongated gripping member comprises a press-fit channel defined in the upper portion of said case for releasably retaining a portion of the elongated gripping member adjacent the second end of thereof.

19. An adjustable-size wrench-type multi-tool, comprising:
an elongated case comprising first and second ends, and upper and lower portions, the upper and lower portions of said elongated case each defining an at least partially-enclosed channel having elongated side walls, said case further comprising a central channel dividing member for dividing the upper and lower at least partially-enclosed channels such that each channel defines upper and lower elongated openings;
an anvil comprising a base portion and an extended portion, the base portion of said anvil being attached to the first end of said case;
a plurality of nubbed pedestals at least partially housed within the at least partially-enclosed channel defined in the upper portion of said case, each nubbed pedestal comprising a pedestal portion and a rounded head portion;
an elongated drive-chain-type gripping member comprising successive linked adjacent bushings, pins, rollers and side plates, first and second ends and an intermediate portion, the first and second ends and intermediate portion of the elongated gripping member together comprising a longitudinal length sufficient and adapted for wrapping in one plane around and engaging any corners of a drivable item lodged against the extended portion of said anvil and adapted for turning the drivable item for loosening and tightening of the drivable item, with a portion of the intermediate portion of said elongated gripping member that is closer to, and together with, the second end of said elongated gripping member being adapted for being releasably but securely fixed on said plurality of nubs for releasably securing said elongated gripping member at least partially within the upper partially-enclosed channel of said case, said elongated gripping member being attached at the first end thereof to the lower portion of said case, adjacent the first end of said case, and adjacent the base portion of said anvil, said elongated gripping member further adapted for release from said plurality of nubbed pedestals and unwrapping in the plane for disengaging the drivable item.
a plurality of tools of at least one of a flat-head screw driver, a phillips-head screw driver, a hex-head driver, a star-head driver, and a knife blade, each of the plurality of tools pivotably housed at least partially within the at least partially-enclosed channel defined in the lower portion of said case and adapted for pivoting exposure and use by a user.

20. The adjustable-size wrench multi-tool of claim 19, wherein the maximum diameter at the enlarged at least partially rounded top of each nubbed pedestal is adapted to be positioned above a diametric centerline of horizontally-positioned adjacent rollers of the elongated drive-chain-type gripping member.
